(19) United States
(12) Patent Application Publication
(10) Pub. No.: US 2016/0082884 A1
(43) Pub. Date: Mar. 24, 2016

(54) WiFi Wireless Rear View Parking System

(71) Applicant: Dae Kwon CHUNG, Fullerton, CA (US)

(72) Inventor: Dae Kwon CHUNG, Fullerton, CA (US)

(21) Appl. No.: 14/494,177

(22) Filed: Sep. 23, 2014

(51) Int. Cl. B60Q 9/00

(52) U.S. Cl. CPC B60Q 9/005; H04W 84/12

(57) ABSTRACT

A WiFi wireless rear view parking system comprises a main body, a camera sensor, a Wifi transmission module, a Wifi reception module, and a display device. The main body is installed at a license plate of an automobile. The camera sensor is provided in the main body for sensing images and video of rear regions of the automobile and generating images and video data. The Wifi transmission module transmits the image and video data from the camera. The Wifi reception module is provided in the automobile for receiving image and video data transmitted by the Wifi transmission module. The display device is provided in the automobile for displaying the images and video data received by the Wifi reception module. The WiFi wireless rear view parking system provides rear view of the automobile to a driver. The WiFi wireless rear view parking system may comprise a microphone and a speaker.

### BACKGROUND OF THE INVENTION

The present invention is related to a WiFi wireless rear view parking system. More particularly, the invention is related to a WiFi wireless rear view parking system, which is convenient to install, use, and maintain.

### SUMMARY OF THE INVENTION

The present invention contrives to solve the disadvantages of the prior art.

An objective of the invention is to provide a WiFi wireless rear view parking system.

An aspect of the invention provides a WiFi wireless rear view parking system.

The WiFi wireless rear view parking system comprises a main body, a camera sensor, a Wifi transmission module, a Wifi reception module, and a display device.

The main body is configured for being installed at a license plate of an automobile.

The camera sensor is provided in the main body and configured for sensing images and video of rear regions of the automobile and generating images and video data.

The Wifi transmission module is configured for transmitting the images and video data from the camera sensor.

The Wifi reception module is provided in the automobile and configured for receiving the images and video data transmitted by the Wifi transmission module.

The display device is provided in the automobile and configured for displaying the images and video data received by the Wifi reception module.

The WiFi wireless rear view parking system is configured to provide rear view of the automobile to a driver of the automobile.

The WiFi wireless rear view parking system may further comprise a microphone and a speaker device.

The microphone may be provided in the main body and configured for sensing sounds and audio of the rear regions of the automobile and generating sounds and audio data.

The speaker device may be provided in the automobile and configured for receiving the sounds and audio data from the microphone and generating sounds and audio.

The Wifi transmission module may be further configured for transmitting the sounds and audio data along with the images and video data.

The WiFi wireless rear view parking system may further comprise a transmission master control circuit for controlling the Wifi transmission module in transmitting the images and video data.

The WiFi wireless rear view parking system may further comprise a first memory device configured for storing data and information used by the camera sensor and the Wifi transmission module.

The first memory device may comprise a flash memory. The WiFi wireless rear view parking system may further comprise a reception master control circuit for controlling the Wifi reception module in receiving the images and video data.

The WiFi wireless rear view parking system may further comprising a second memory device configured for storing data and information used by the display device and the Wifi reception module.

The second memory device may comprise a flash memory.

The main body may be a bar-type.

Alternatively, the main body may be a full-frame-type.

Still, the main body may be a heavy-duty mounting bracket-type.

The WiFi wireless rear view parking system may further comprise a hard-wired camera installed in the main body of a heavy-duty mounting bracket-type.

The WiFi wireless rear view parking system may further comprise a switch for switching between reverse and non-reverse view images.

The advantages of the present invention are: (1) the WiFi wireless rear view parking system is simple in structures; and (2) the WiFi wireless rear view parking system is convenient to install, use, and maintain.

Although the present invention is briefly summarized, the fuller understanding of the invention can be obtained by the following drawings, detailed description and appended claims.

### BRIEF DESCRIPTION OF THE DRAWINGS

These and other features, aspects and advantages of the present invention will become better understood with reference to the accompanying drawings, wherein:

FIG. 1 shows WiFi wireless rear view parking systems of different types according to embodiments of the invention;

FIGS. 2A-1, 2A-2, and 2B-1 though 2B-4 show a transmission part schematic diagram of the WiFi wireless rear view parking system according to an embodiment of the invention;

FIGS. 3A-1 through 3A-4 and 3B-1 through 3B-3 show a receiving part schematic diagram of the WiFi wireless rear view parking system of an embodiment of the invention;

FIG. 4 is a bar-type WiFi wireless rear view parking systems according to another embodiment of the invention;

FIG. 5 is a bar-type WiFi wireless rear view parking systems according to still another embodiment of the invention;

FIG. 6 is a WiFi wireless rear view parking systems according to still another embodiment of the invention;

FIGS. 7A through 7D and 8A through 8C show a user's manual for a WiFi wireless rear view parking system according to an embodiment of the invention; and

FIG. 9 and FIG. 10 show an operation guide of a WiFi wireless rear view parking system according to an embodiment of the invention.

### DETAILED DESCRIPTION OF THE INVENTION

An aspect of the invention provides a WiFi wireless rear view parking system.

The WiFi wireless rear view parking system 100 comprises a main body 10, a camera sensor 20, a Wifi transmission module 30, a Wifi reception module 40, and a display device 50.

The main body 10 is configured for being installed at a license plate of an automobile 90.

The camera sensor 20 is provided in the main body 10 and configured for sensing images and video of rear regions of the automobile 90 and generating images and video data.

The Wifi transmission module 30 is configured for transmitting the images and video data from the camera sensor 20. Usually, the Wifi transmission module 30 is provided integrally with the main body 10 or the camera sensor 20 or an attachment to ether of them.

The Wifi reception module 40 is provided in the automobile 90 and configured for receiving the images and video data transmitted by the Wifi transmission module 30.

The display device 50 is provided in the automobile 90 and configured for displaying the images and video data received by the Wifi reception module 40. The Wifi reception module 40 may be provided as a part of the display device.

The WiFi wireless rear view parking system 100 is configured to provide rear view of the automobile 90 to a driver of the automobile 90.

The WiFi wireless rear view parking system 100 may further comprise a microphone (not shown) and a speaker device (not shown). The microphone can be installed beside of the camera sensor 20, and the speaker can be installed beside the display device 50.

The microphone may be provided in the main body 10 and configured for sensing sounds and audio of the rear regions of the automobile 90 and generating sounds and audio data.

The speaker device may be provided in the automobile 90 and configured for receiving the sounds and audio data from the microphone and generating sounds and audio.

The Wifi transmission module 30 may be further configured for transmitting the sounds and audio data along with the images and video data.

The WiFi wireless rear view parking system 100 may further comprise a transmission master control circuit for controlling the Wifi transmission module in transmitting the images and video data.

The WiFi wireless rear view parking system 100 may further comprise a first memory device configured for storing data and information used by the camera sensor and the Wifi transmission module.

The first memory device may comprise a flash memory.

The WiFi wireless rear view parking system 100 may further comprise a reception master control circuit for controlling the Wifi reception module in receiving the images and video data.

The WiFi wireless rear view parking system 100 may further comprising a second memory device configured for storing data and information used by the display device and the Wifi reception module.

The second memory device may comprise a flash memory.

The main body 10 may be a bar-type.

Alternatively, the main body 10 may be a full-frame-type.

Still, the main body 10 may be a heavy-duty mounting bracket-type.

The WiFi wireless rear view parking system 100 may further comprise a hard-wired camera installed in the main body 10 of a heavy-duty mounting bracket-type.

The WiFi wireless rear view parking system 100 may further comprise a switch for switching between reverse and non-reverse view images.

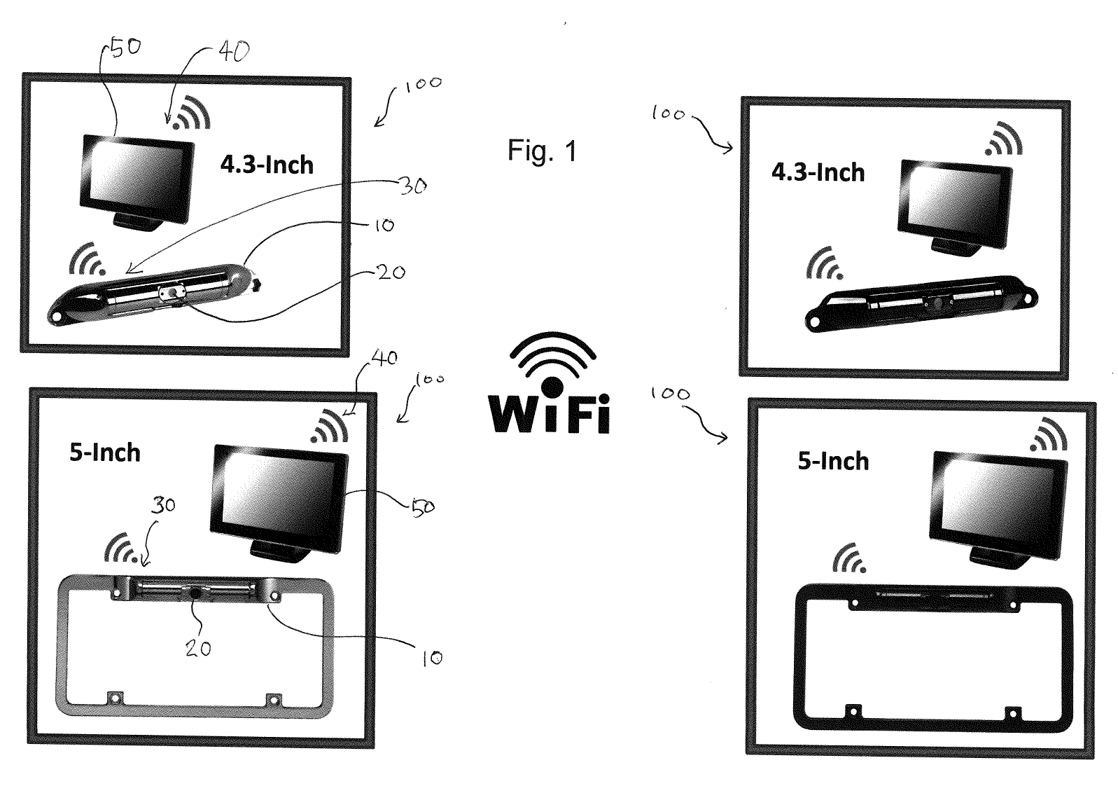

In FIG. 1, a WiFi wireless rear view parking system can be realized in many forms or types. It can come as a bar-type or full-frame type. That is, it can be installed anywhere around the vehicle, or on a license plate frame at the rear of the car.

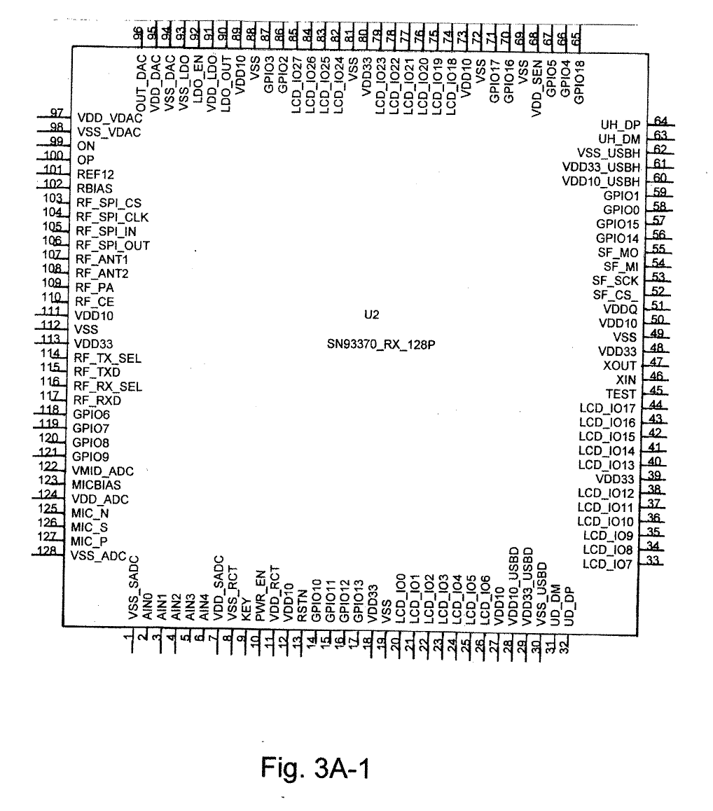

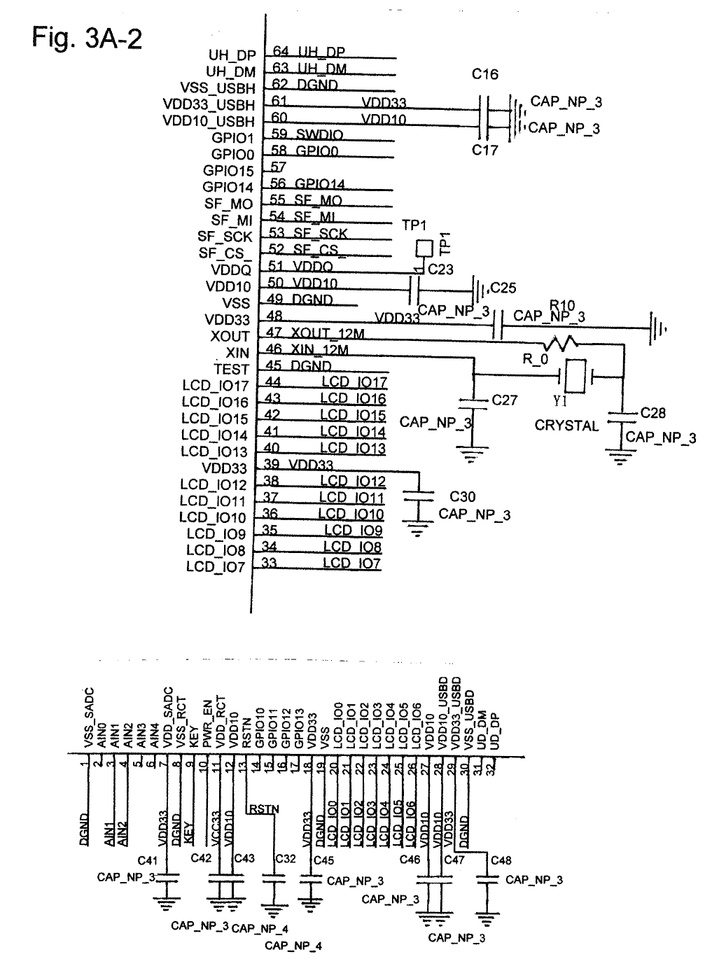

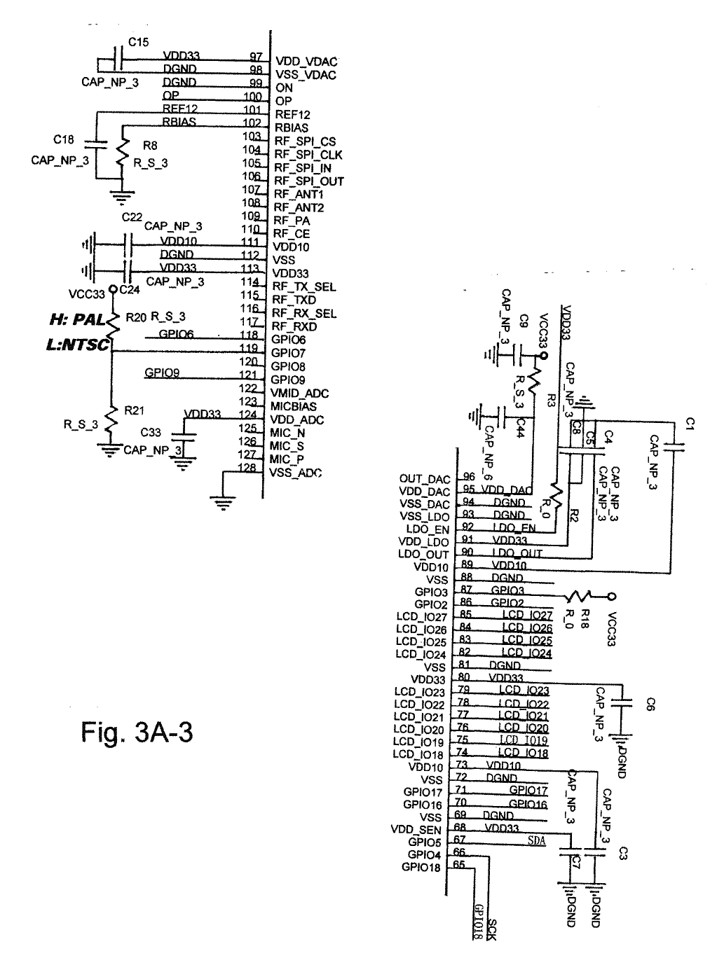

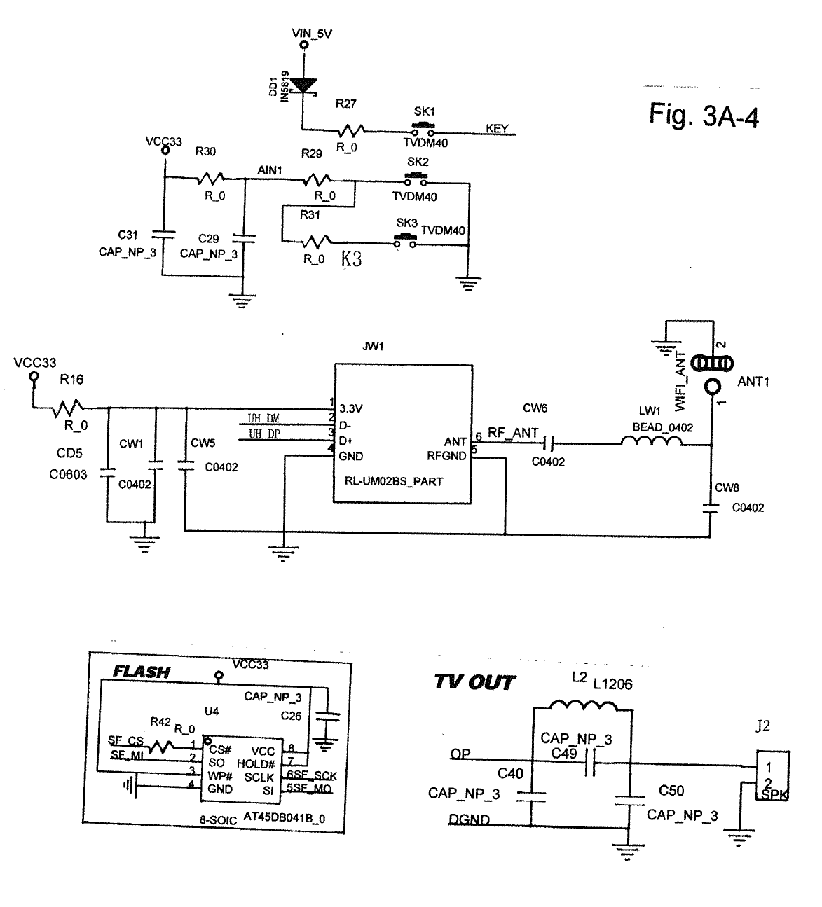

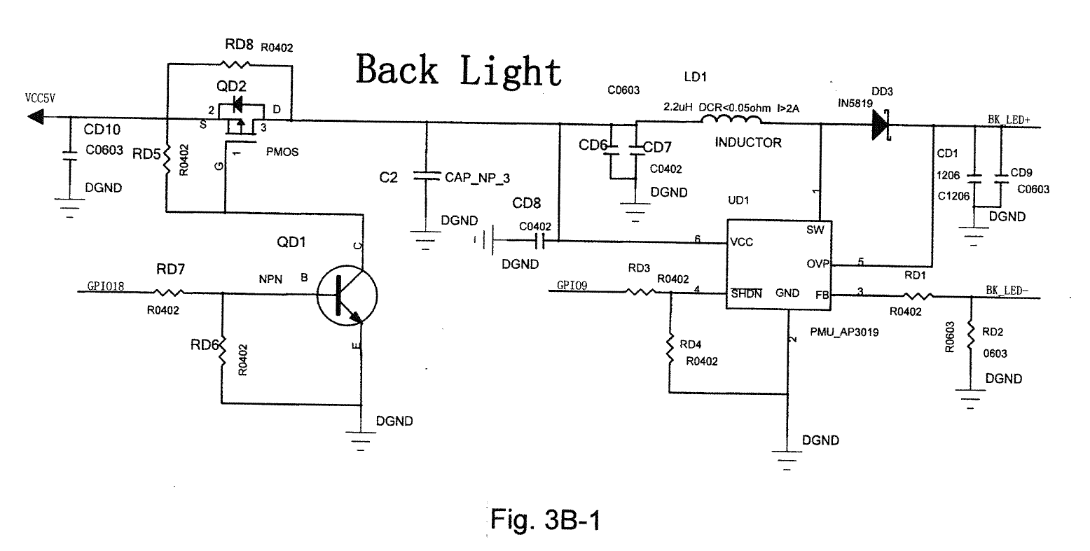

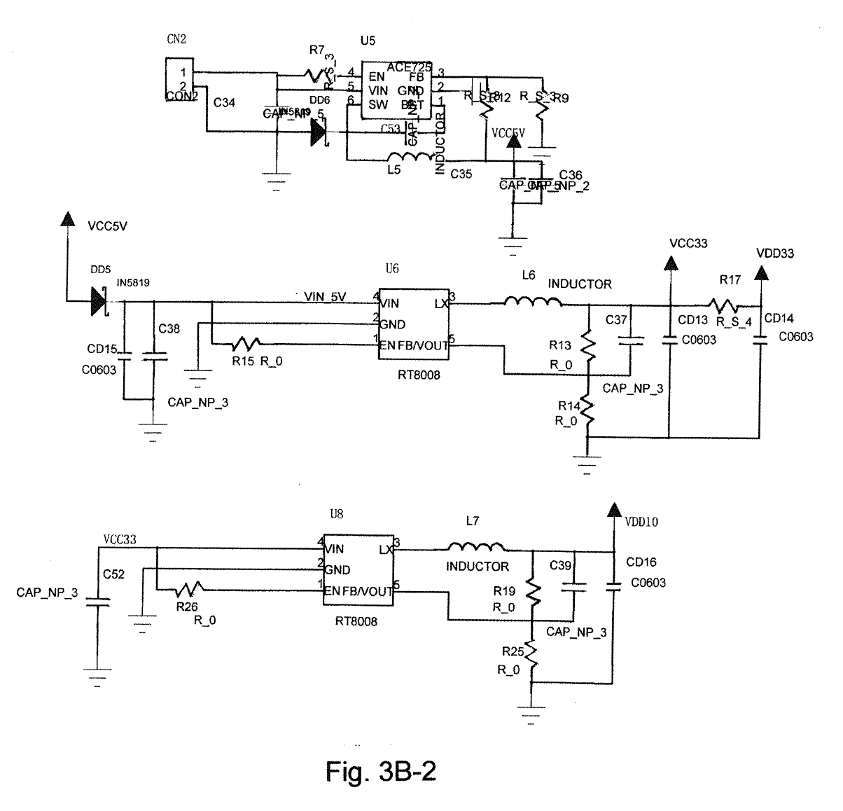

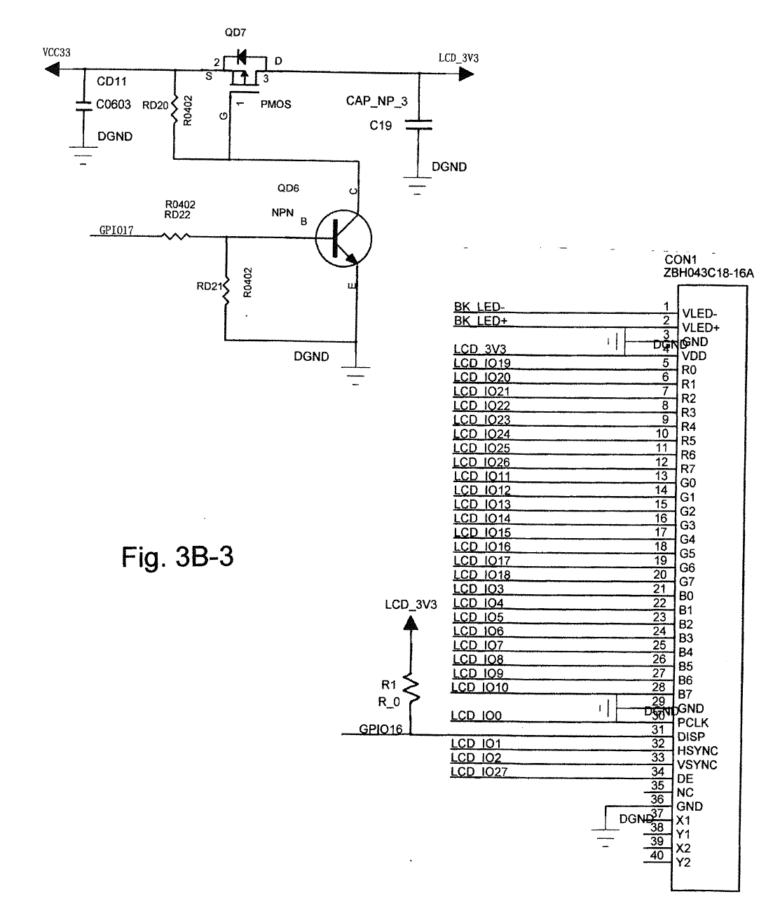

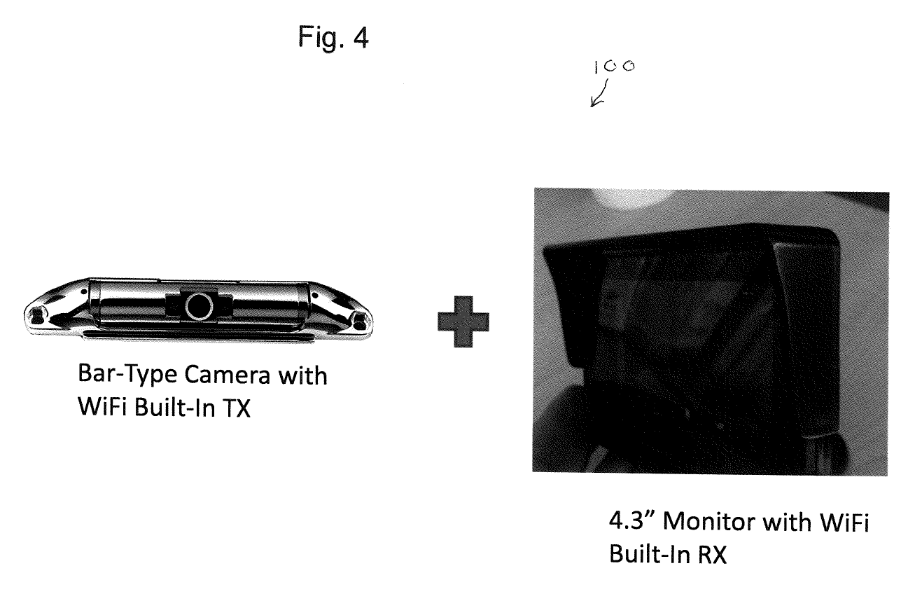

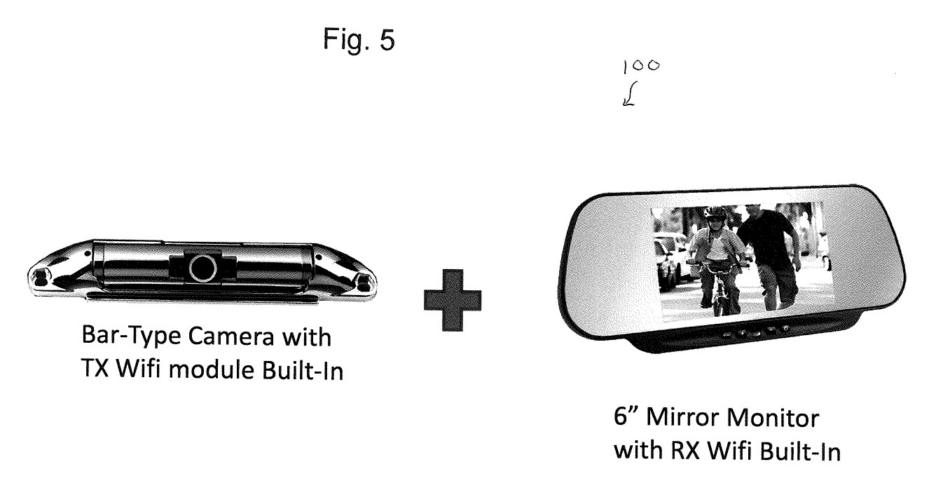

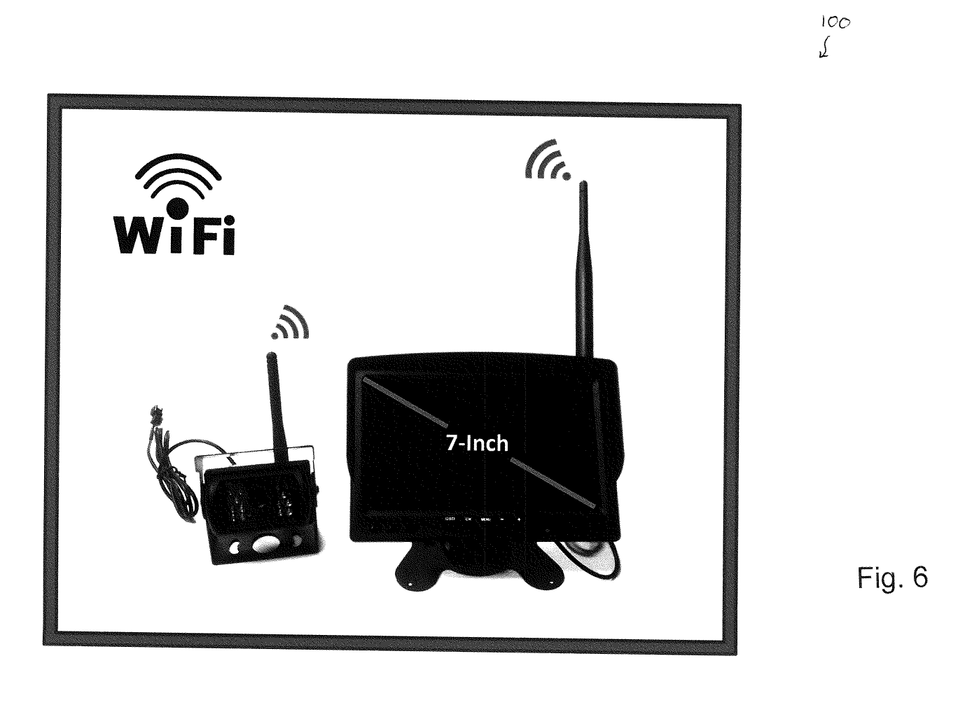

Even though FIGS. 2A-1, 2A-2, 2B-1 through 2B-4, 3A-1 through 3A-4, and 3B-1 through 3B-3 show detailed circuit diagrams, they are just for an example, not limiting. As far as it performs functions, any type of electronic circuits or devices may be used therefor. FIGS. 4 through 6 show some of such situations.

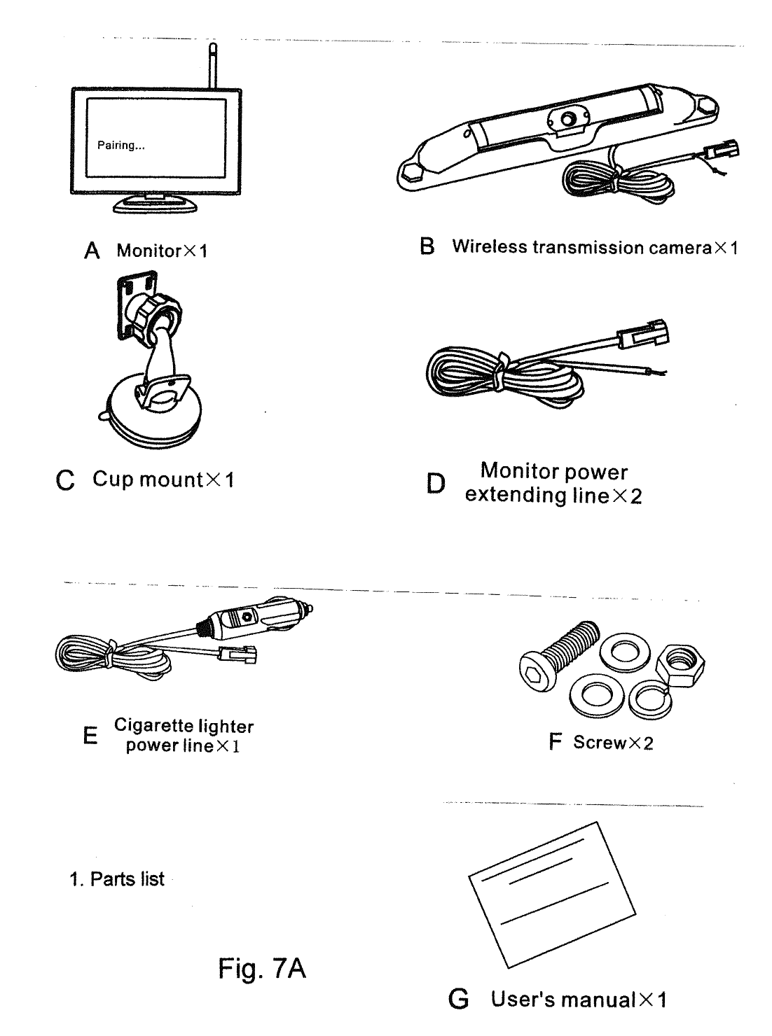

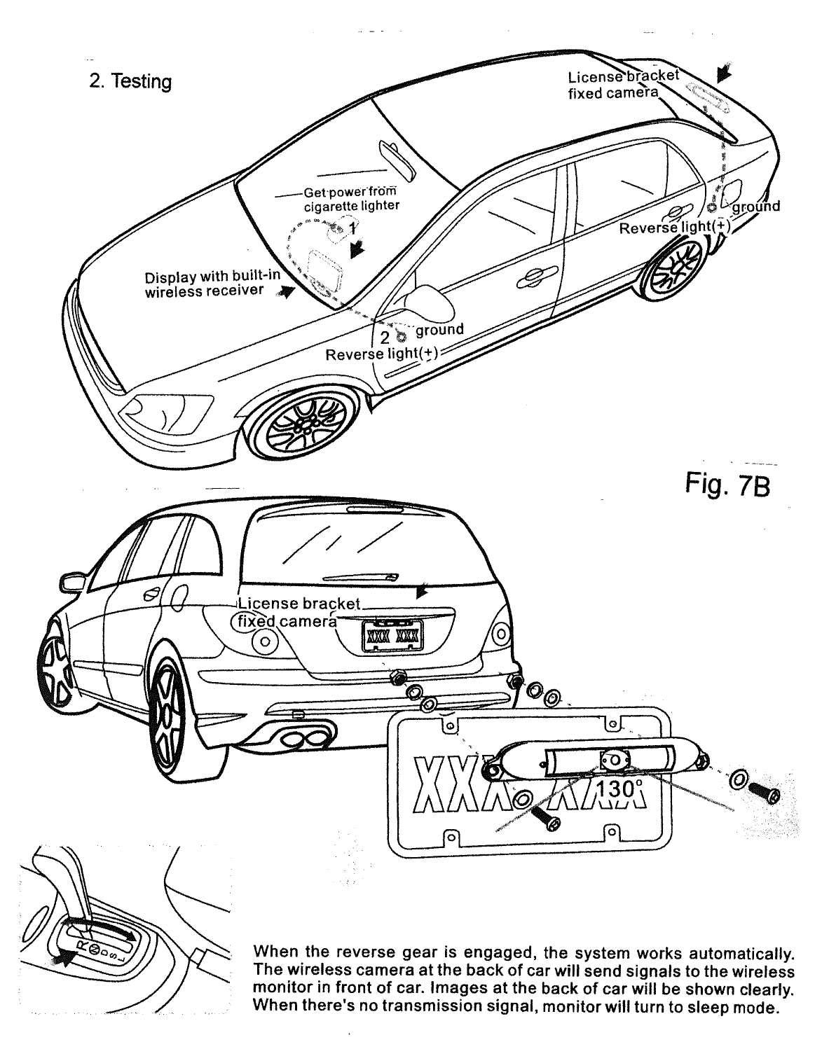

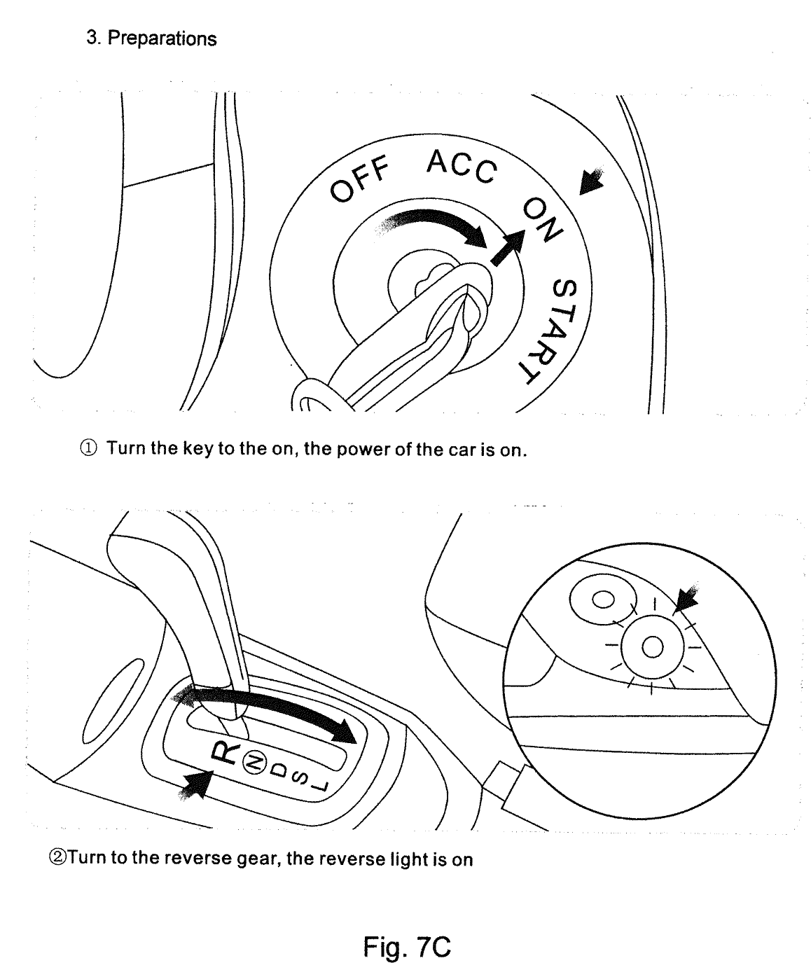

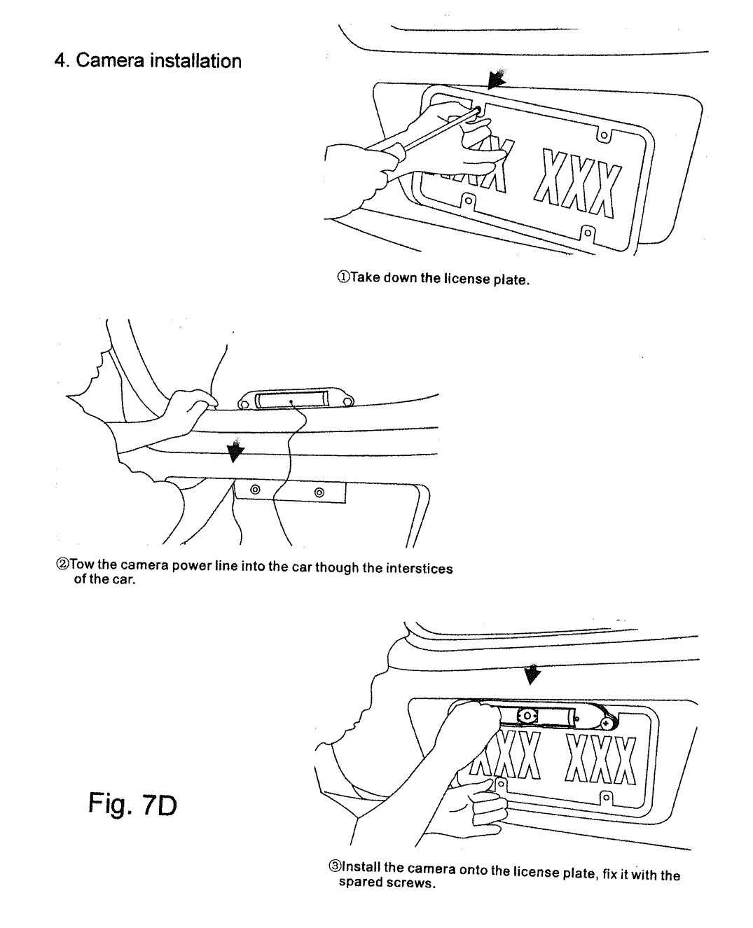

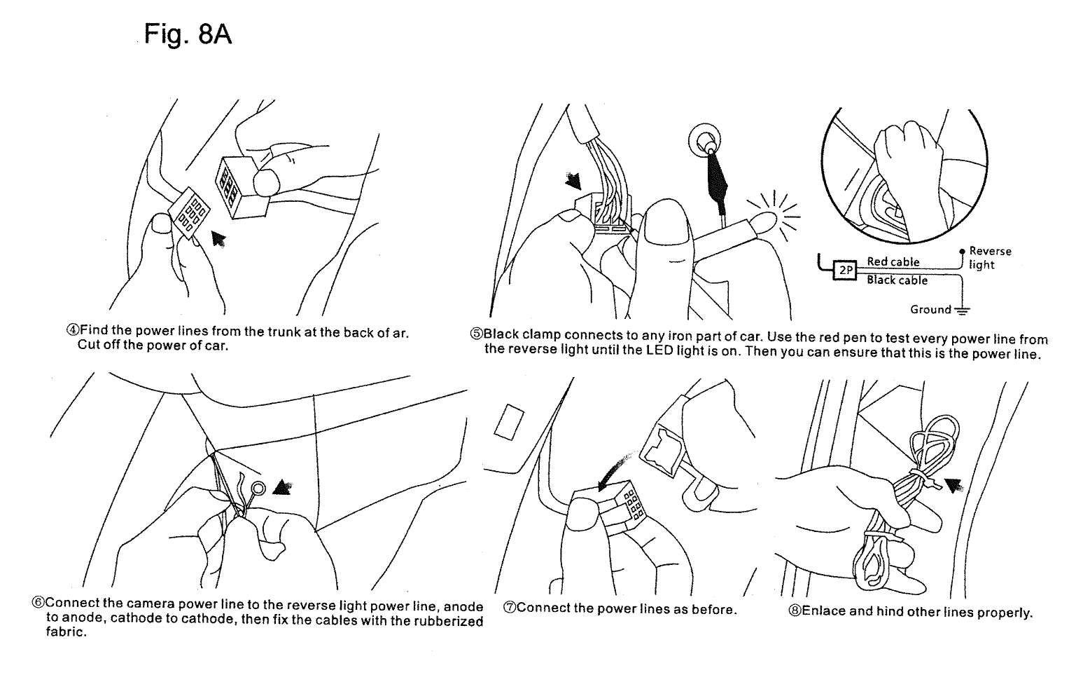

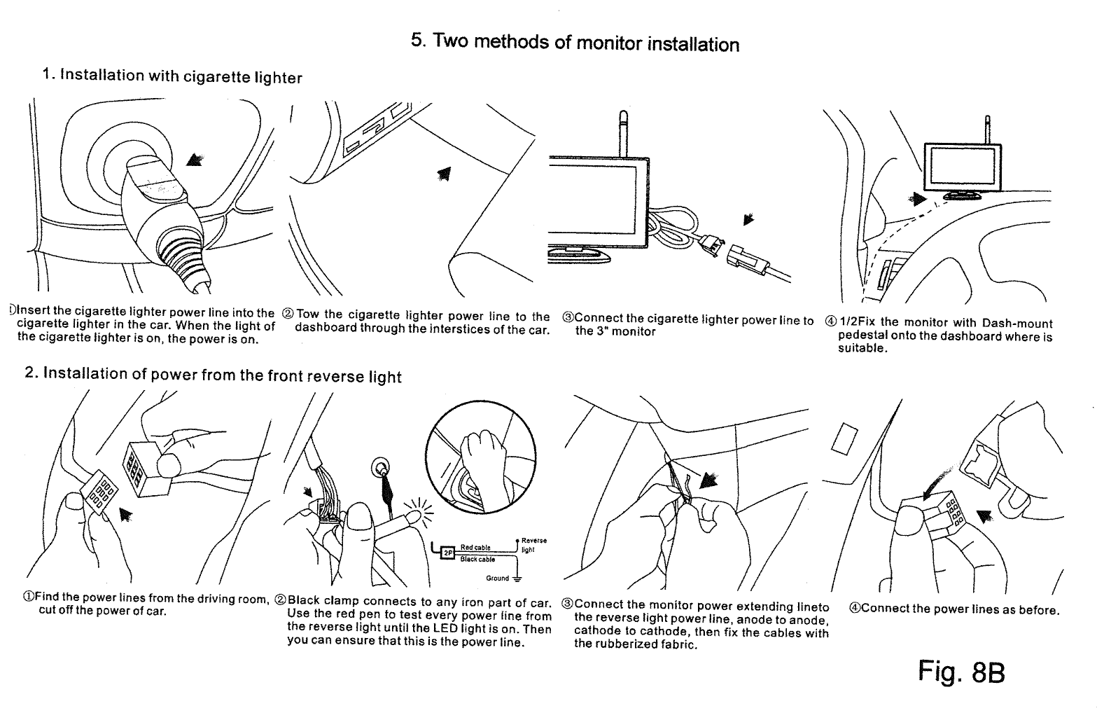

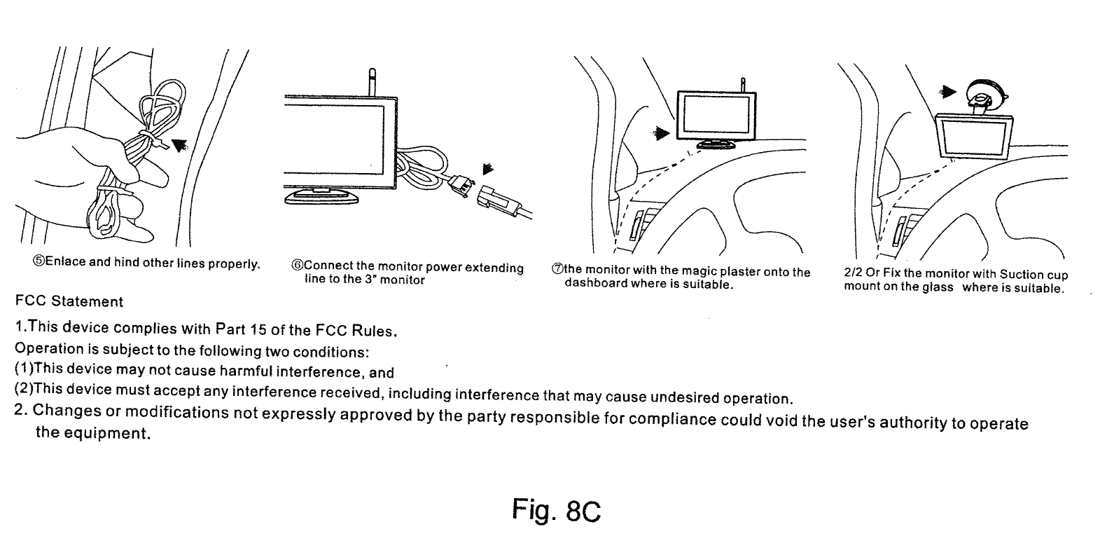

In the user's manual in FIGS. 7A through 7D and 8A through 8C, some more details in a specific embodiment can be seen about installing, using, and maintaining of the WiFi wireless rear view parking system according to an embodiment of the invention.

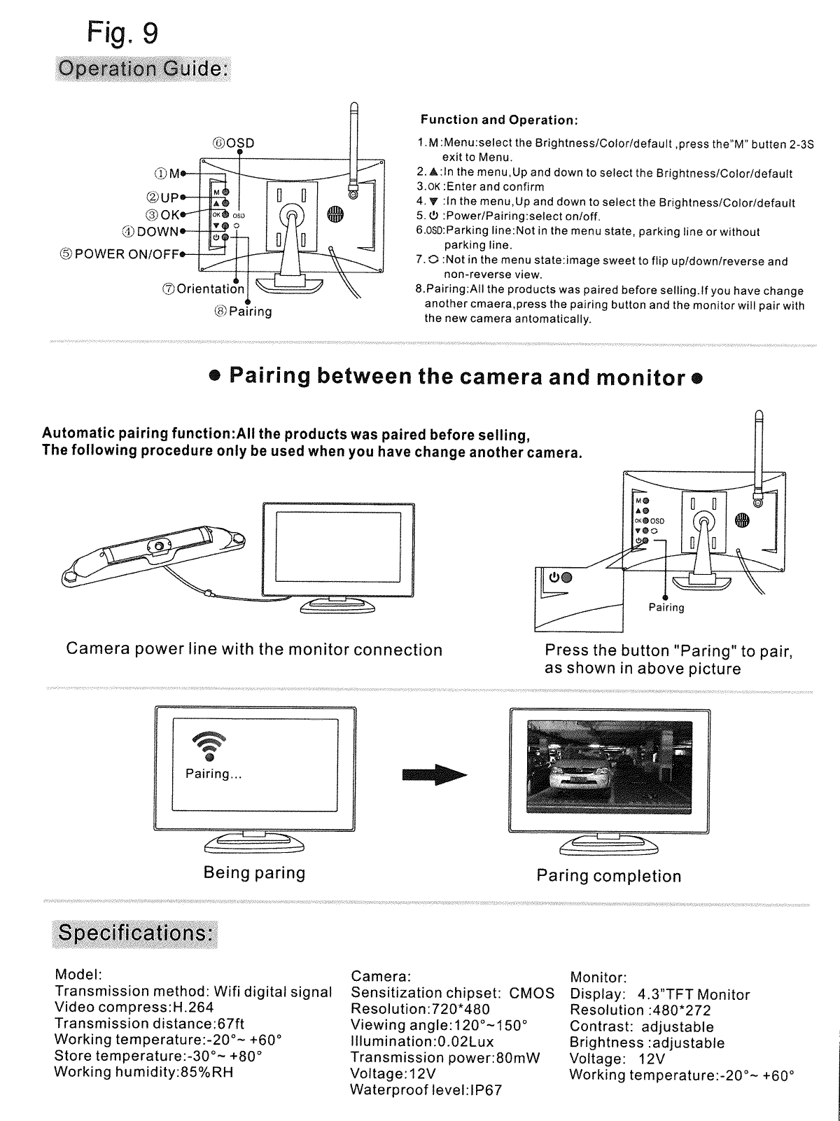

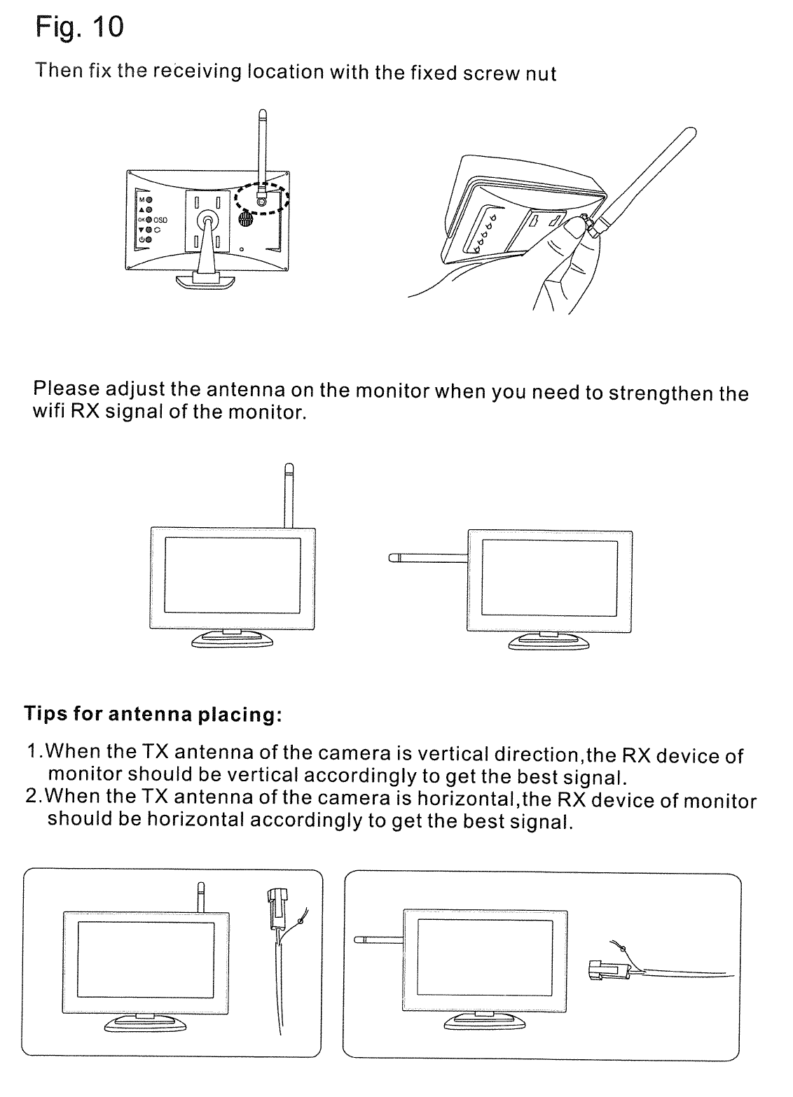

In the operation guide in FIG. 9 and FIG. 10, some other aspects of the WiFi wireless rear view parking system according to an embodiment of the invention.

### Techno Sphere

This WiFi wireless rear view parking system belongs to the field of vehicle safety warning device, especially related to a rear view parking system.

### BACKGROUND TECHNOLOGY

For a long time, car rear view reversing has always been a big problem for the car driver. Particularly, in the bad climate conditions and the narrow parking area, will make it easy to have a collision. Now, there is some kind reversing warning device, when reversing, the buzzer makes sounds, but the drivers can't detailed know the circumstances and the orientation, the size and the shape of the obstacle. Another kind of rear view parking system, with a camera install in the back of the car which help the drivers to see the rear image, but with the difficult installation and connection, it is not easy to install. And the other one analog signal wireless transmission rear view parking system with rear camera, though it is easy to install, the image quality is poor and it is easy to be vulnerable to the outside interference. There is also the one digital signal wireless transmission rear view parking system with rear camera, easy to install, not easy to be vulnerable to the outside interference, but the data transmission rate is low, the image quality is poor. The above reversing systems all have their own flaw. On the installation, the signal processing part and the display part rely on cables, which connect from the rear of the car to the front of the car, make it difficult to install. Or the video signal is very poor which is vulnerable to be interfered, effect the safety of reversing.

### Contents of the Invention

The Utility model Wifi Wireless Rear view Parking System aim to avoid the shortcomings of existing technology, provide a simple circuit structure, stable performance, Wifi wireless transmission and receiving function, high data transmission rate, clear picture quanlity, easy to install and convenient to observe.

The purpose of the Utility model Wifi Wireless Rear view Parking System through the following measures to achieve, which formed with the transmission part and the receiving part. The transmission part is formed with power circuit, camera sensor, microphone, transmission mater control IC, Wifi module and flash. The receiving part is formed with power circuit, Wifi module, receiving master control IC, flash, voice-frequency circuit and display circuit. Power circuit provide corresponding voltage, the camera sensor input the video signal to the transmission master control IC, the video signal is encoded inside the transmission master control IC, and the send out via the Wifi module. The Wifi module in the receiving part receive the video signal, will input the video signal to the receiving master control IC, output the video signal to the display circuit, video signal input to the monitor. The video signal through the Wifi wireless transmission to the receiving part.

The Utility model Wifi Wireless Rear View System is a kind of wireless technology with 2.4G frequency range, the biggest advantage is high transmission speed, can reach to 11 Mbps, the effective distance is longer, can reach 50 meters, signal delay is less than 100 ms, video resolution can reach 720*480, or even higher. But the common digital wireless transmission, the transmission speed is lower, generally speaking, it is 3 Mbps, video resolution is 320*240, so that the picture quality is poorer, signal delay is lower. By comparison, Wifi wireless transmission image quality is clearer, faster response time.

The Utility model Wifi Wireless Rear View System with simple circuit structure, stable performance, easy to install and convenient to observe, Wifi wireless transmission and receiving function, improve the safety in reversing, can be widely used in all kinds of vehicles for reversing.

### Specific Embodiments

Here below combined with the appended drawings for further instructions.

As shown in FIG. 1, a WiFi wireless rear view parking system is formed with the transmission part and the receiving part. The transmission part is formed with power circuit, camera sensor, transmission master control chip, Wifi module and flash. The receiving part is formed with power circuit, Wifi module, receiving master control chip, flash and monitor. Power circuit provide DC stabilized power supply, the camera sensor in the transmission part input the video signal to the transmission master control chip, the video is encoded inside the transmission master control chip, the Wifi module send out the encoded video signal. After the Wifi module in the receiving part receive the video signal, will input the video signal to the receiving master control chip, the video signal is decoded inside the receiving master control chip, video signal input to the monitor. The transmission part and the receiving part has a corresponding flash, make the master control chip internal initialization setting. The video signal in the transmission part transmit to the receiving part via Wifi wireless.

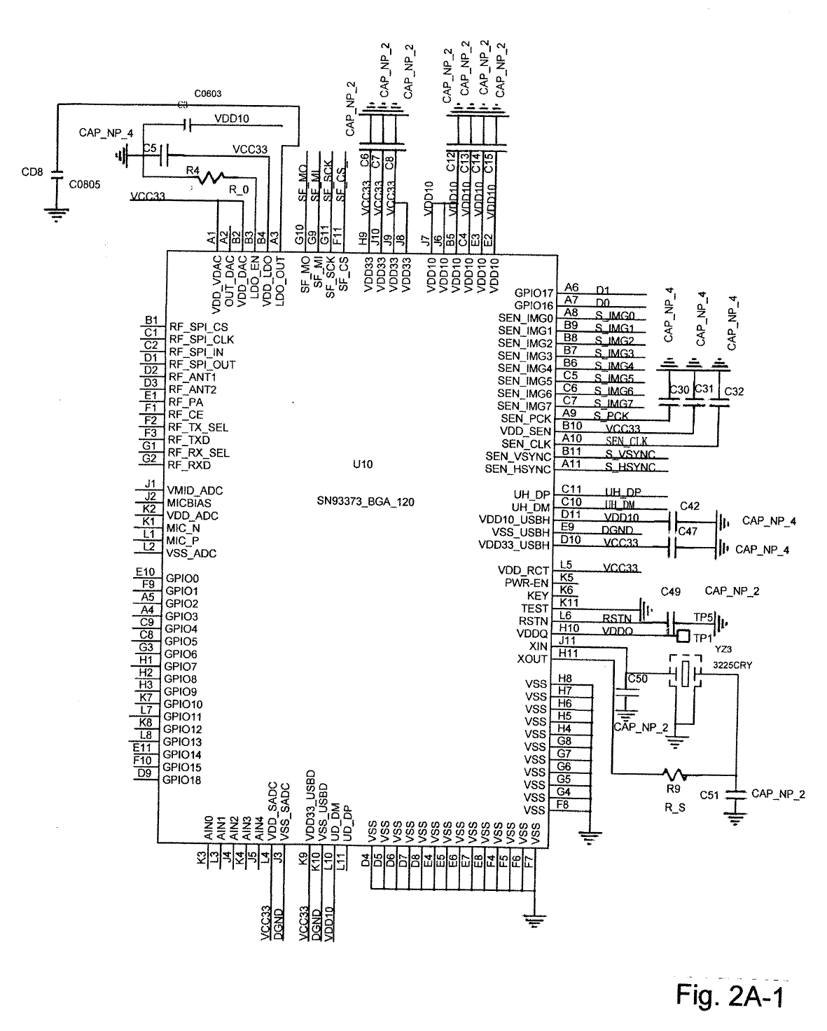

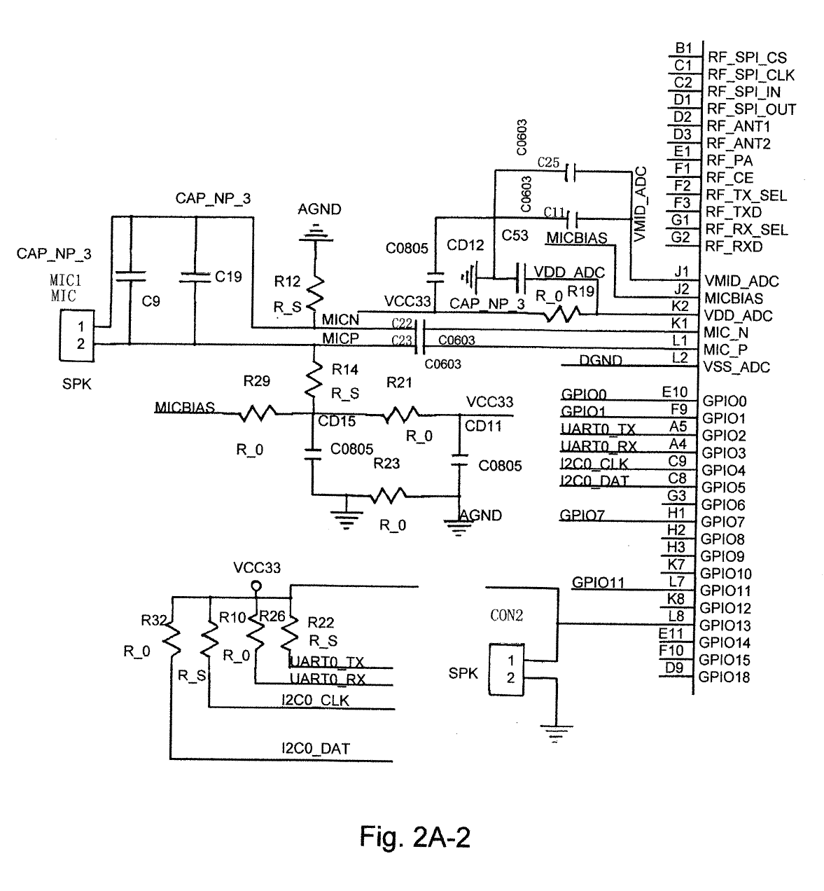

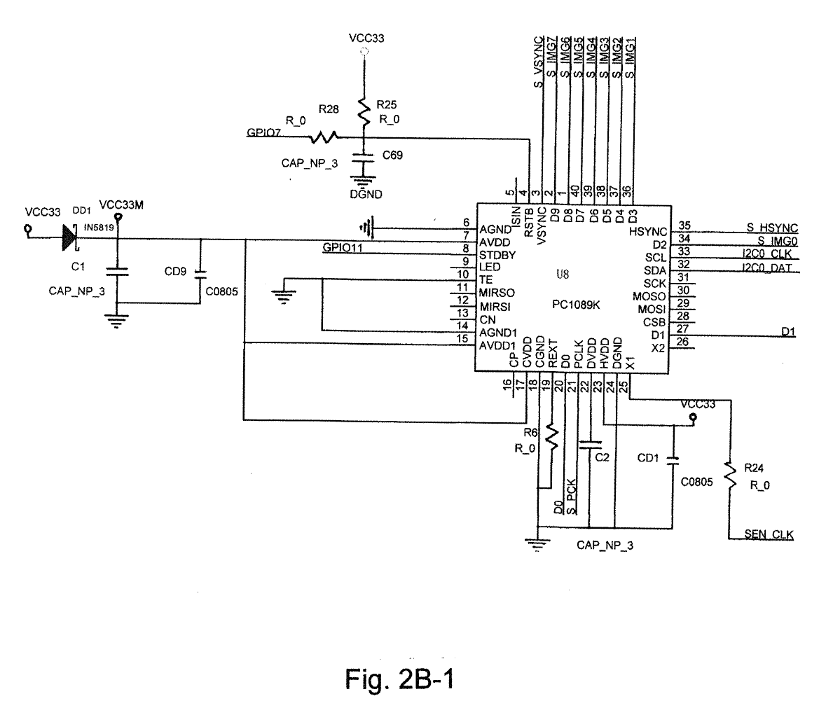

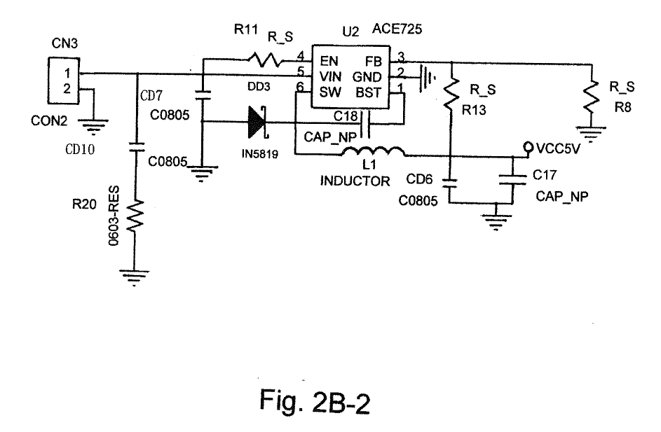

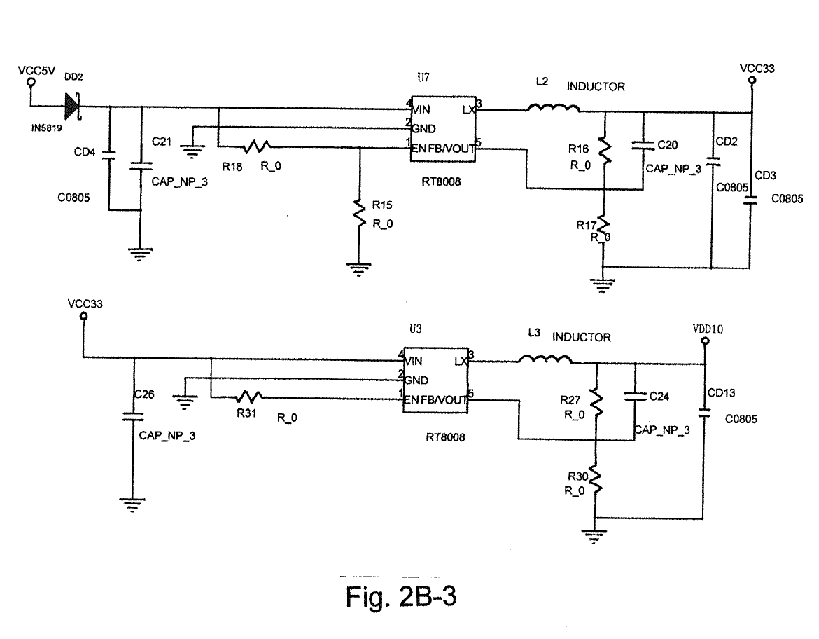

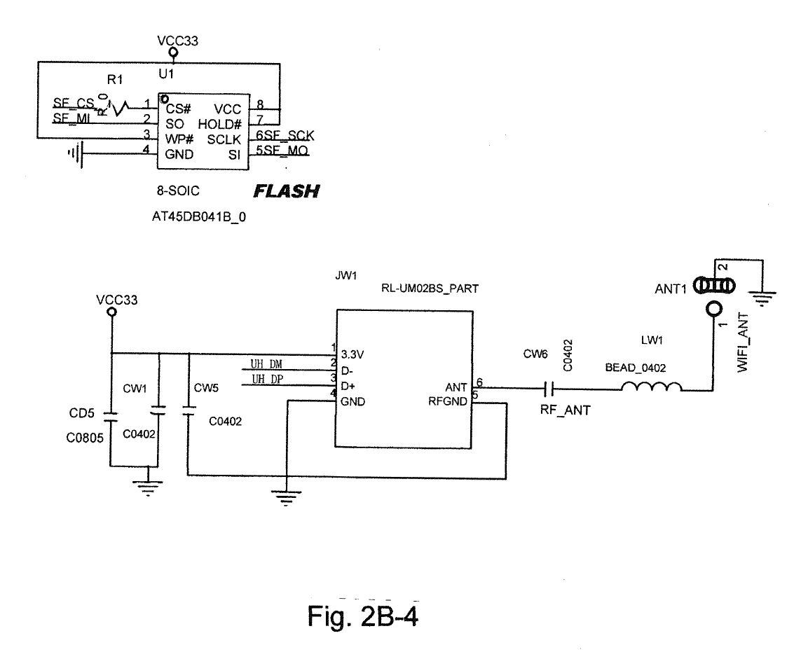

As shown in FIGS. 2A-1, 2A-2, and 2B-1 though 2B-4, the transmission part of the Utility model Wifi Wireless Rear View System is formed with power circuit, camera sensor, transmission master control chip, Wifi module and flash. Power circuit is formed with U2, U3, U7, capacity and inductance, provide DC stabilized power supply, camera sensor is U8, U8 collect the light signal, and transformed into video signal, then input to transmission master control chip U10, the video signal encoded by the transmission master control chip U10, then sent out by the Wifi module JW1.U1 make U10 internal initialization setting.

As shown in FIGS. 3A-1 through 3A-4 and 3B-1 through 3B-3, the receiving part of the Utility model Wifi Wireless Rear View System is formed with power circuit, Wifi module, receiving master control chip, flash and monitor. Power circuit is formed with U1, U3, U7, capacity and so on. Provide the receiving part the required voltage. Wifi module JW1 receive the signal, will input the signal to the receiving master control chip U2, the signal is decoded inside the receiving master control chip U2, the decoded signal input to the monitor CON2 (TFT monitor), the camera images will display on the monitor. Flash is U4, U4 make U2 internal initialization setting.

The Utility model Wifi Wireless Rear View System can be matched with different sizes of TFT LCD minitor, such as 4.3 inch, 5 inch, 6 inch, 7 inch.

The Utility model Wifi Wireless Rear View System with simple circuit structure, stable performance, easy to install and convenient to observe, Wifi wireless transmission and receiving function, improve the safety in reversing, can be widely used in all kinds of vehicles for reversing.

While the invention has been shown and described with reference to different embodiments thereof, it will be appreciated by those skilled in the art that variations in form, detail, compositions and operation may be made without departing from the spirit and scope of the invention as defined by the accompanying claims.

What is claimed is:

1. A WiFi wireless rear view parking system comprising:
a main body configured for being installed at a license plate of an automobile;
a camera sensor provided in the main body and configured for sensing images and video of rear regions of the automobile and generating images and video data;
a Wifi transmission module configured for transmitting the images and video data from the camera sensor;
a Wifi reception module provided in the automobile and configured for receiving the images and video data transmitted by the Wifi transmission module; and
a display device provided in the automobile and configured for displaying the images and video data received by the Wifi reception module,
wherein the WiFi wireless rear view parking system is configured to provide rear view of the automobile to a driver of the automobile.

2. The WiFi wireless rear view parking system of claim 1, further comprising:
a microphone provided in the main body and configured for sensing sounds and audio of the rear regions of the automobile and generating sounds and audio data; and
a speaker device provided in the automobile and configured for receiving the sounds and audio data from the microphone and generating sounds and audio.

3. The WiFi wireless rear view parking system of claim 2, wherein the Wifi transmission module is further configured for transmitting the sounds and audio data along with the images and video data.

4. The WiFi wireless rear view parking system of claim 1, further comprising a transmission master control circuit for controlling the Wifi transmission module in transmitting the images and video data.

5. The WiFi wireless rear view parking system of claim 1, further comprising a first memory device configured for storing data and information used by the camera sensor and the Wifi transmission module.

6. The WiFi wireless rear view parking system of claim 5, wherein the first memory device comprises a flash memory.

7. The WiFi wireless rear view parking system of claim 1, further comprising a reception master control circuit for controlling the Wifi reception module in receiving the images and video data.

8. The WiFi wireless rear view parking system of claim 1, further comprising a second memory device configured for storing data and information used by the display device and the Wifi reception module.

9. The WiFi wireless rear view parking system of claim 7, wherein the second memory device comprises a flash memory.

10. The WiFi wireless rear view parking system of claim 1, wherein the main body is a bar-type.

11. The WiFi wireless rear view parking system of claim 1, wherein the main body is a full-frame-type.

12. The WiFi wireless rear view parking system of claim 1, wherein the main body is a heavy-duty mounting bracket-type.

13. The WiFi wireless rear view parking system of claim 1, further comprising a hard-wired camera installed in the main body of a heavy-duty mounting bracket-type.

14. The WiFi wireless rear view parking system of claim 13, further comprising a switch for switching between reverse and non-reverse view images.
